(19) United States
(12) Patent Application Publication
(10) Pub. No.: US 2015/0057987 A1
(43) Pub. Date: Feb. 26, 2015

(54) METHOD AND APPARATUS FOR ESTIMATION OF OUT-OF-PLANE DEFORMATION OF CABLE

(71) Applicant: Hitachi Metals, Ltd., Tokyo (JP)

(72) Inventors: Tomohisa SUZUKI, Tokyo (JP); Takeshi TERASAKI, Tokyo (JP); Fumihito OKA, Hitachi (JP); Hirotaka ESHIMA, Hitachi (JP)

(21) Appl. No.: 14/459,382

(22) Filed: Aug. 14, 2014

(30) Foreign Application Priority Data
Aug. 21, 2013 (JP) 2013-170992
Mar. 14, 2014 (JP) 2014-051089

(51) Int. Cl. G06F 17/50

(52) U.S. Cl. CPC G06F 17/5018
USPC 703/2

(57) ABSTRACT

An estimation apparatus executes an estimation method of out-of-plane deformation of a cable having a winding curl, the method including an input step of inputting parameters needed for the estimation; a step of deriving a value of an equivalent material property of the cable; a step of making a finite element analysis model reproducing the winding curl; a step of deforming the cable model to be in a straight state and calculating a stress distribution; a step of setting a rotational angle for determining an installation direction of the winding curl; a step of setting the calculated stress distribution and the set rotational angle to be initial states, deforming the straight cable model according to a load condition input at the input step, and calculating a deformation state and an amount of the out-of-plane deformation; and a step of outputting calculation results to an output device.

### CROSS REFERENCE TO RELATED APPLICATIONS

This application claims the foreign priority benefit under Title 35, United States Code, 119(a)-(d) of Japanese Patent Applications No. 2013-170992 and No. 2014-051089 which are filed on Aug. 21, 2013 and Mar. 14, 2014, respectively in the Japan Patent Office, each disclosure of which is herein incorporated by reference in its entirety.

### BACKGROUND OF THE INVENTION

1. Technical Field

The present invention relates to a method and an apparatus for estimation of out-of-plane deformation of a cable and the dispersion of the deformation.

2. Description of Background Art

There exist strong requirements for the protection of the global environment and for the energy saving nowadays. So, an electric vehicle (EV) using an electric motor as a main power source, and a fuel cell electric vehicle (FCEV) have been developed energetically. As to a drive mechanism for such a vehicle, a system of just replacing a conventional engine (internal combustion engine) with an electric motor, and in-wheel type motor system in which an electric motor is disposed in a wheel to directly drive the wheel, are proposed. The in-wheel type motor system is receiving a lot of attention as a very unique drive mechanism in views of becoming needless of a conventional engine compartment, of enabling an independent drive for wheels, and so on.

Power supply is done to the in-wheel type motor system from the outside of an electric motor incorporated in a wheel through a power cable. The power cable receives a bending movement repeatedly in accordance with movements of a suspension when the vehicle is running and so on. At this time, it is very important that the power cable is pulled around so that excessive tensile stress is not generated in the power cable, the power cable does not come into contact with a structural member around the power cable or with the rotating wheel, or so on.

On the other hand, as to a twisted wire cable pulled around in a bend-moving zone in a vehicle like a door zone, a method of visualizing a bent state of a plurality of conductive wires constituting the twisted wire cable is disclosed, for example, in the patent document 1.

Patent document 1: Japanese Unexamined Patent Publication No. 2009-266775

### BRIEF SUMMARY OF THE INVENTION

In an electric vehicle according to the in-wheel type motor system, there is a possibility that a power cable for an in-wheel type motor unexpectedly comes into contact with a structure member around the power cable. This means that the power cable has been deformed in a direction deviated from a direction in a plane in which the power cable is moved to be bent when the power cable receives a bending movement repeatedly in accordance with movements of a suspension. The above deformation of the power is called cable out-of-plane deformation in this specification.

The patent document 1 discloses things about a method of visually grasping the bent state of the conductive wires constituting the cable when the cable is bent with a curvature, and about the visualization system. The bent state of the conductive wires to be calculated when the bent state is visually grasped is obtained by a geometric calculation without considering a stress distribution in the cable. The out-of-plane deformation is caused by a stress distribution in the cable, so the invention disclosed in the patent document 1 cannot treat the out-of-plane deformation of the problem in the present application.

Since unexpected contact of the power cable with a structure member around the power cable results in the damage of the power cable as time passes, enough clarification needs to be done.

In order to solve the above problem, the object of the present invention is to clarify causes of out-of-plane deformation of a cable and the dispersion of the deformation, and to provide a method for estimation of the out-of-plane deformation of a cable and an apparatus for the estimation of the out-of-plane deformation of the cable, which method and apparatus can estimate the deformation and the dispersion of the deformation in advance on a design stage.

In order to achieve the object, a method for estimation of out-of-plane deformation of a cable to be executed by an apparatus for estimation of out-of-plane deformation of the cable with reference to a datum plane, the cable having a winding curl which forces the cable to be an arc form under a stress-free-load state and including a conductor (for example, central conductor 12) and a resin sheath covering the conductor, the deformation being caused when the cable is set in a horizontal state, a vertical plane including an axis of the cable in the horizontal state is set to be the datum plane, and the cable is bent in a vertical direction, includes: an input step of inputting parameters needed for the estimation of the out-of-plane deformation of the cable (for example, step S101); an equivalent material property derivation step of deriving a value of an equivalent material property of the whole of the cable based on a stress-strain curve obtained by measurement (for example, step S102); a winding curl form making step of making a finite element analysis model of the cable with use of the derived value of the equivalent material property of the cable, which model reproduces a form having a radius of curvature of the winding curl input at the input step (for example, step S103); a residual stress distribution calculation step of deforming the cable model having the radius of curvature of the winding curl to be in a straight state and calculating a stress distribution in the straight cable model (for example, step S104); a rotational angle setting step of setting a rotational angle around an axis of the straight cable model for determining an installation direction of the winding curl (for example, step S105); a cable deformation state calculation step of setting the calculated stress distribution and the set rotational angle to be initial states, deforming the straight cable model according to a load condition input at the input step, and calculating a deformation state and an amount of the out-of-plane deformation of the deformed cable model (for example, step S106); and a calculation result output step of outputting calculation results of the deformation state and the amount of the out-of-plane deformation of the deformed cable model to an output device (for example, step S109).

According to the present invention, the out-of-plane deformation of a cable and the dispersion of the deformation can be estimated in advance on a design stage.

### BRIEF DESCRIPTION OF THE SEVERAL VIEWS OF THE DRAWING

Certain preferred embodiments of the present invention will now be described in greater detail by way of example only and will reference to the accompanying drawings, in which:

FIG. 1 is a schematic view showing an example of a cable layout and a structure around an in-wheel type motor when the inside of the wheel is viewed from a side of the vehicle;

FIG. 2 is a schematic view showing the example of the cable layout and the structure around the in-wheel type motor when the inside of the wheel is viewed from the upper side of the vehicle in FIG. 1;

FIG. 3 is a schematic sectional view showing an example of a cable to be used as the power cable;

FIG. 4 is a block diagram showing an apparatus for estimation of out-of-plane deformation of a cable and the dispersion of the deformation;

FIG. 5 is a flow chart showing a method for estimation of out-of-plane deformation of a cable and the dispersion of the deformation;

FIGS. 6A to 6G are explanation views showing an example of modeling; and

FIG. 7 is an explanation view showing an installation direction of a cable against a winding curl of the cable.

### DETAILED DESCRIPTION OF THE INVENTION

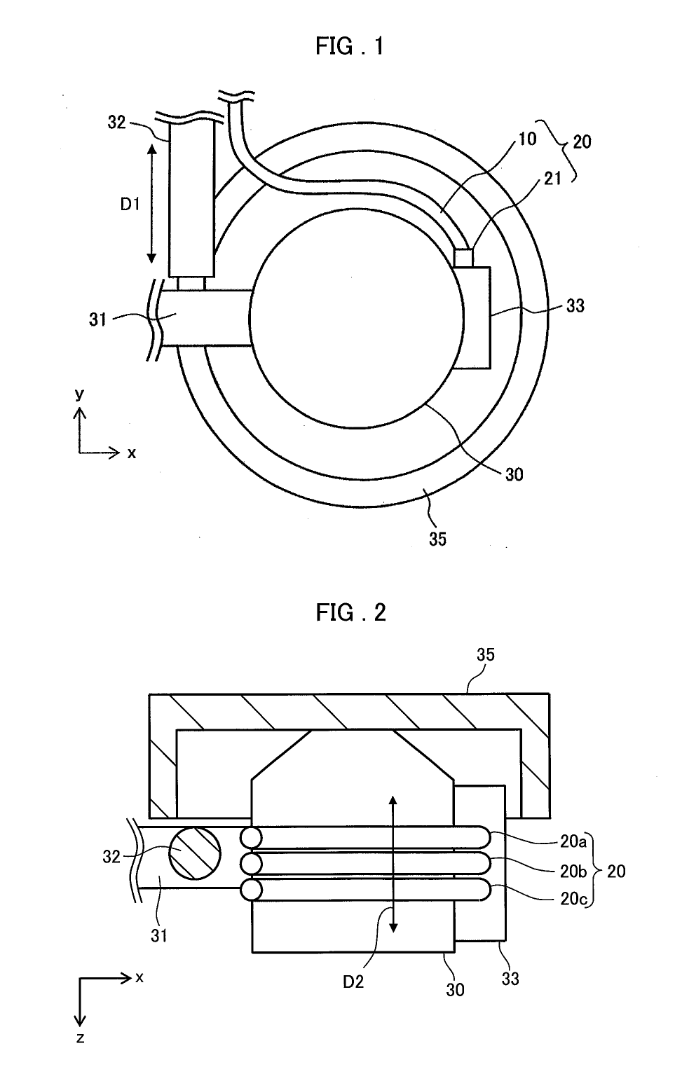

An embodiment of the present invention will be described in detail with reference to the attached drawings. Firstly, an example of a structure around an in-wheel type motor and a cable layout will be described with reference to FIGS. 1 and 2.

### (Cable Layout)

FIG. 1 is a schematic view showing an example of a cable layout and a structure around an in-wheel type motor when the inside of the wheel is viewed from a side of the vehicle. FIG. 2 is a schematic view showing the example of the cable layout and the structure around the in-wheel type motor when the inside of the wheel is viewed from the upper side of the vehicle in FIG. 1. The in-wheel type motor 30 is fixed to a suspension arm 31 together with a suspension 32 so that a rotating shaft of the motor 30 is disposed to be a shaft of the wheel 35.

Downsizing to arrange the in-wheel type motor 30 within a space defined by the wheel 35, and a high output power for the vehicle to run are both required for the in-wheel type motor 30. For this reason, a three-phase alternating current electric motor is usually used for the in-wheel type motor 30. Then a plurality of power cables 20, for example, three power cables 20a, 20b, and 20c, are connected to the in-wheel type motor 30 through a connecting terminal 21 and a terminal base 33. Therefore, the power cables 20 for supplying electric power to the in-wheel type motor 30 are pulled around inevitably in a small space.

Furthermore, the power cables 20 receive a bending movement repeatedly in accordance with the movements of the suspension 32 when the vehicle is running and so on. For example, the bending movement is caused in a direction D1 shown in FIG. 1, in which direction D1 the suspension 32 operates. It is very important that the power cables 20 are pulled around so that excessive tensile stress is not generated in each power cable 20, and the cables 20 do not come into contact with a structural member around the cables 20, for example, the suspension 32, nor the rotating wheel 35 (including also a tire).

As having described in BRIEF SUMMARY OF THE INVENTION as a problem to be solved by the invention, in an electric vehicle according to the in-wheel type motor system, there is a possibility that the power cables 20 for the in-wheel type motor 30 unexpectedly come into contact with a structure member around the power cables. This means that a power cable 20 is deformed in a direction deviated from a direction in a plane (direction in an x-y plane in FIG. 1) in which the power cable 20 is bent when the power cable 20 receives a bending movement repeatedly in accordance with the movements of the suspension 32. For example, out-of-plane deformation, which is a deformation deformed in a direction D2 in FIG. 2, is caused.

Investigation for the deformation has been done upon various power cables 20 by the inventors. The result designates that a state and degree of the investigated out-of-plane deformation are different every power cable 20, and, at first, a consistent tendency has not been found. In other words, a cause or causes of the out-of-plane deformation and dispersion of the deformation have not been found, so the estimation of them has been considered to be hard. But, the inventors have solved the problem based on the following essential thought.

### (Essential Thought of Invention)

The inventors have investigated things regarding manufacture of a cable or a conductor (electric wires) constituting the power cable 20 in order to clarify a cause or causes because of which a state and degree of out-of-plane deformation of a power cable 20 are largely different every power cable 20 when each power cable 20 is suffered a bending movement.

A cable is usually kept in a state wound around a bobbin or drum until the cable is processed to be a final product because the cable is a long product. The cable is cut out from the bobbin or drum by the predetermined length so that the cut-out cable with the predetermined length is processed with an end process to produce the power cable 20. Some cut-out cables each has a winding curl remained therein. It is said that such winding curl of a cable is caused by viscoelasticity of a sheath material and/or an insulation material of resin. Furthermore, it is thought that such winding curl of a cable depends also on material of a sheath material and/or an insulation material, the preservation period of the cable since the time of production of the cable, and the diameter of a bobbin or drum on which the cable has been wound.

Then, the inventors has furthermore investigated and researched in detail about a relation between the winding curl and the state and degree of the out-of-plane deformation of a power cable 20 on the premise that a cable having the winding curl is used. Thus the inventors have found that the state and degree of the out-of-plane deformation of a power cable 20 are strongly influenced by a relation between a direction of the winding curl to be used and a direction of a bending movement to be applied on the power cable 20. The present invention is based on this finding.

### (Cable Structure)

FIG. 3 is a schematic sectional view showing an example of a cable to be used as the power cable. The power cable 20 includes a cable 10 and the connecting terminal 21 (refer to FIG. 1). The cable 10 has a central conductor 12 (conductor), an insulation layer 13, a reinforcing braided layer 14, and a resin sheath 15, and these (layers) are arranged in a radial direction sequentially from the central conductor 12. And the connecting terminal 21 is formed at a longitudinal end of the cable 10 as shown in FIG. 1. The cable 10 has a winding curl which forces the cable 10 to be an arc form under a stress-free-load state.

A sectional structure of the cable 10 is not limited to that shown in FIG. 3. The sectional structure needs to have only the central conductor 12 and the resin sheath 15 of the outermost layer, but the other structure is not limited to the example shown in FIG. 3. Note that, in this embodiment, the stress-free-load state means a state in which the cable 10 is statically laid on a plate having a surface as smooth as possible, that is, a surface having a surface friction as small as possible. As to the plate, for example, there is a plate made of polytetrafluoroethylene (PTFE) and having a finished surface, or an ice plate having a finished surface.

In this embodiment, it is preferable that the central conductor 12 is a twisted wire formed of a plurality of element wires 11. The reason is the following. In general, the twisted wire conductor has a high bending resistance because an even stress is generated in each element wire 11 when the twisted wire conductor is bent. In FIG. 3, the central conductor 12 of the twisted wire has 29 element wires 11, but it is not limited to that. Furthermore, each element wire 11 may be a twisted wire formed of a plurality of finer element wires.

Material and a thickness of each of the insulation layer 13, the reinforcing braided layer 14, and the resin sheath 15 are not limited to specific ones, so they may be appropriately selected so as to fit to specifications of an electric device (for example, the in-wheel type motor 30) to which the power cable 20 (refer to FIG. 1) is connected. For example of the cable 10, in a case where a diameter of the central conductor 12 is 3.4 mm, a polyethylene (PE) layer having a thickness of 0.5 mm can be used for the insulation layer 13, a braided layer braided by fibers of polyethylene terephthalate (PET) having a thickness of 1.0 mm can be used for the reinforcing braided layer 14, and an ethylene propylene diene monomer rubber (EPDM) layer having a thickness of 0.8 mm can be used for the resin sheath 15.

### (Structure of Apparatus for Estimation)

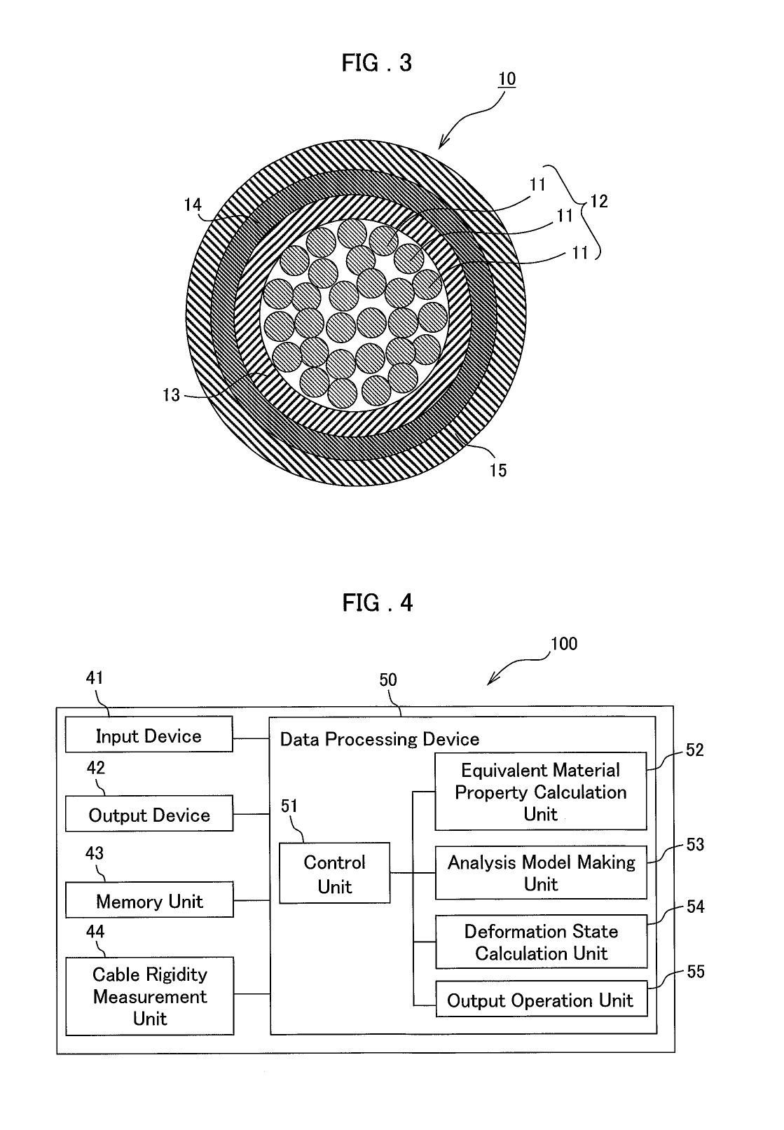

FIG. 4 is a block diagram showing an apparatus for estimation of out-of-plane deformation of a cable and the dispersion of the deformation. The apparatus 100 for estimation includes an input device 41, an output device 42, a memory unit 43, a cable rigidity measurement unit 44, and a data processing device 50 as shown in FIG. 4. The input device 41 includes a keyboard and a mouse. The output device 42 includes a display and a printer. The memory unit 43 includes a hard disc for storing various kinds of information. The cable rigidity measurement unit 44 is a unit for measuring the rigidity of the cable 10. The data processing device 50 is a device for performing a process to estimate the out-of-plane deformation of the cable 10 and the dispersion of the deformation based on various data input by the input device 41 and/or the cable rigidity measurement unit 44.

The input device 41 has a role to input parameters needed for calculation and information regarding a form of the cable 10. The output device 42 outputs a result operated by the data processing device 50.

The data processing device 50 has a control unit 51, an equivalent material property derivation unit 52, an analysis model making unit 53, a deformation state calculation unit 54, and an output operation unit 55. The control unit 51 comprehensively controls each function in the data processing device 50. The equivalent material property derivation unit 52 calculates an equivalent material property based on a stress-strain curve obtained by the cable rigidity measurement unit 44. The analysis model making unit 53 makes an input data file for an analysis of the cable 10 according to the finite element method with use of various kinds of parameters input by the input device 41. The deformation state calculation unit 54 performs the analysis according to the finite element method with use of the input data file which has been made, to calculate a deformation state of the cable 10. The output operation unit 55 operates to output results of the deformation state of the cable 10, the dispersion of the out-of-plane deformation, the stress, and so on, and outputs those to the output device 42.

### (Method for Estimation)

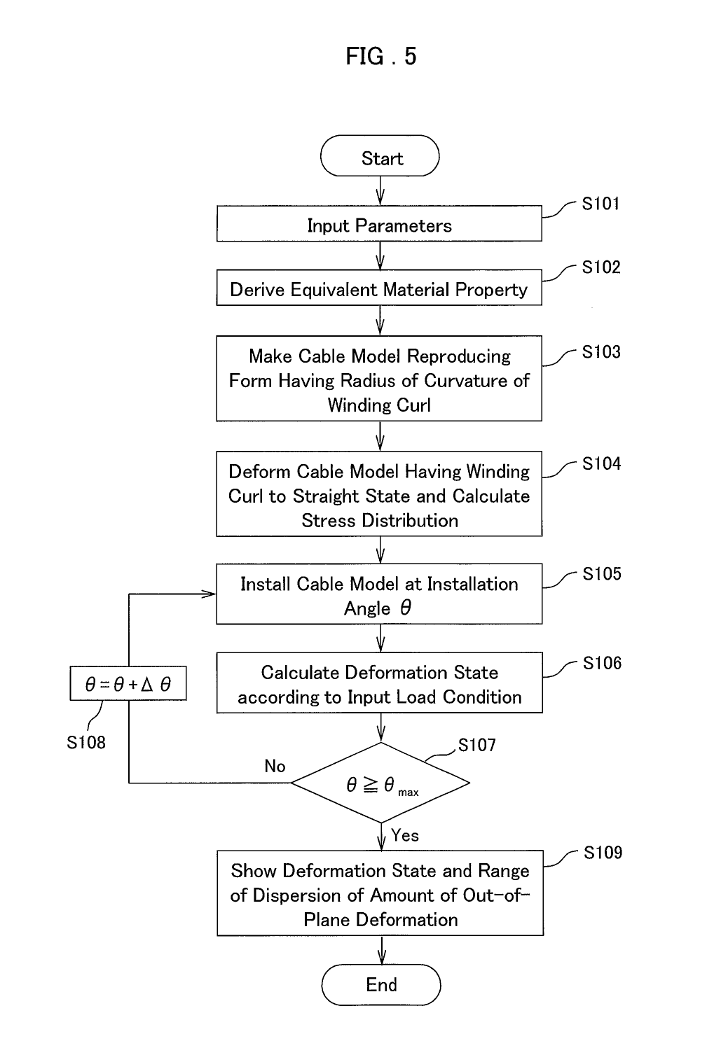

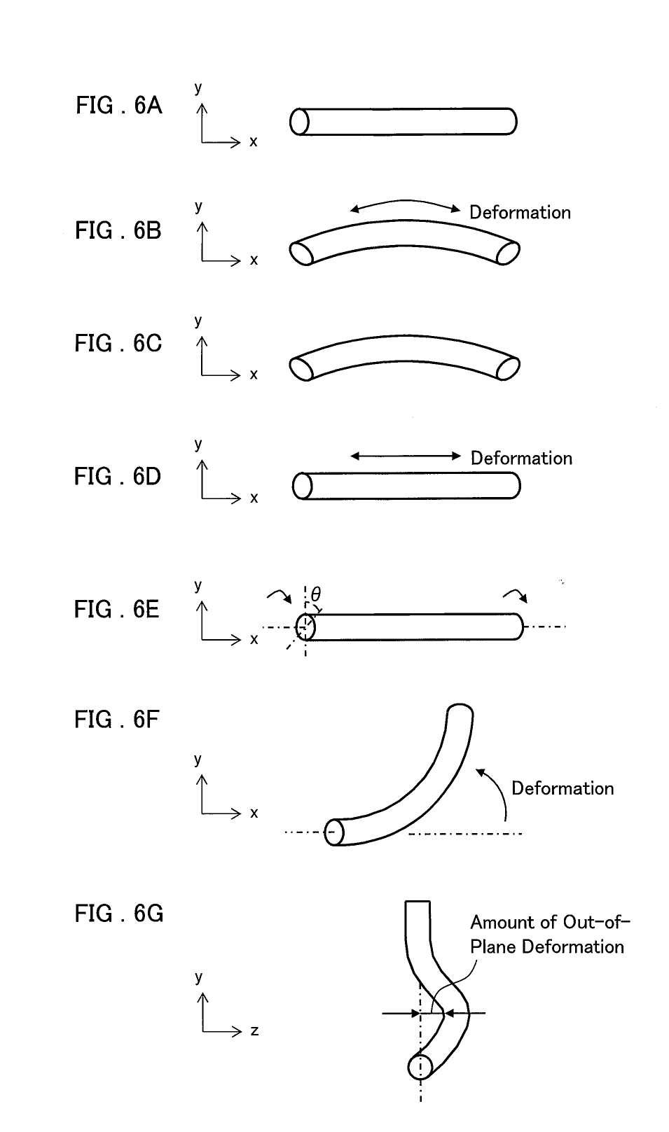

Next, a specific process which the apparatus 100 for estimation performs will be described in detail with reference to FIGS. 5 and 6. FIG. 5 is a flow chart showing a method for estimation of out-of-plane deformation of a cable and the dispersion of the deformation, and FIG. 6 is an explanation view showing an example of modeling. FIGS. 3 and 4 are also appropriately referred to.

(Step S101): The data processing device 50 can receive the input of various kinds of input parameters needed for calculation of an equivalent material property of the cable 10, and for estimation of the dispersion of out-of-plane deformation. The input is done through the input device 41, and is stored in the memory unit 43. The input parameters includes a length of the cable 10, a radius of the cable 10, a twisting type of the element wires 11, a radius of an element wire 11, the number of element wires 11, a twisting pitch of the element wires 11, a radius of curvature of a winding curl of the cable 10, an increment in an installation direction (angle increment Δθ), and loading conditions. The loading conditions are of a selected type of load and a size of the load when the selected type of load is adopted. The type of load is, for example, a load to bend it to be in an L form, in an S form, or so on. The size of the load relates to the radius of curvature, geometrical positional relation, and so on. Note that, the installation direction will be explained at step S105.

(Step S102): The equivalent material property derivation unit 52 calculates an equivalent material property considering all components of the cable 10, that is, the central conductor 12, the resin sheath 15, and so on shown in FIG. 3. This means that material property of the cable 10 is replaced with one material property, that is, with the equivalent material property, by considering the cable 10 to be a cable made of homogenous substance. Furthermore, it is preferable that the conductor section (central conductor 12) is modeled as a truss element which takes charge of an axial force only, and is embedded inside the analysis model of the homogenous substance body. The equivalent material property of the homogenous substance body section is calculated based on a stress-strain curve obtained by the cable rigidity measurement unit 44. The stress-strain curve of the cable 10 can be obtained by a bending test like the three points bending test.

The analysis model making unit 53 makes an analysis model (hereinafter, finite element analysis model) of the cable 10 for the finite element method, which cable 10 is a cable of an object that the cable rigidity measurement unit 44 has measured. The equivalent material property derivation unit 52 calculates a stress-strain curve with use of the finite element analysis model and virtual material property. Then, difference between the stress-strain curve obtained by the measurement and the stress-strain curve obtained by the calculation is evaluated. The material property for which the difference is the smallest within a predetermined range of material property and within a repeat count number is searched, so that an equivalent material property is calculated. The comprehensive search method, the minimum gradient method, the genetic algorithm, and so on can be used as the searching algorithm.

As to the model for material (components), for an example, the region except the conductor section of the cable 10 can be approximated by replacing the region with an elasto-plasticity body, and the conductor section can be approximated by replacing the conductor section with an elastic body.

(Step S103): The analysis model making unit 53 makes a finite element analysis model of the cable 10 having a winding curl based on input parameters of a radius and a length of the cable 10, a radius of curvature of the winding curl, a twisting type of the element wires 11, a radius of an element wire 11, the number of element wires 11, and a twisting pitch of the element wires 11. The finite element analysis model of the cable 10 having a winding curl can be made through the following process.

Firstly, the analysis model making unit 53 makes a finite element analysis model of a straight cable 10 according to the input parameters (corresponding to FIG. 6A). Secondly, the deformation state calculation unit 54 makes a deformed model of a deformed cable from the finite element analysis model of the straight cable according to the input radius of curvature of the winding curl (corresponding to FIG. 6B). Next, only information about the form (or shape) obtained at the second process (that is, information about stress and so on are excluded) is transferred to the following step as a finite element analysis model (corresponding to FIG. 6C).

(Step S104): The deformation state calculation unit 54 deforms the finite element analysis model made at step S103 to be in a straight state, and calculates a stress distribution in the cable (corresponding to FIG. 6D).

(Step S105): The deformation state calculation unit 54 sets a rotational angle around the axis of the cable 10 to determine the installation direction for the winding curl, and installs the cable model (finite element analysis model) deformed to be in the straight state at the set rotational angle (installation angle) θ (an initial value of θ is zero degrees) (corresponding to FIG. 6E).

Note that, in this embodiment, the cable 10 including the conductor and the resin sheath 15 covering the conductor is set in a horizontal state. Then, a vertical plane along (or including) the axis of the cable 10 is set to be a datum plane, and the cable 10 is bent in a vertical direction. The rotational angle around the axis of the cable 10 is set to be an angle measured with reference to the datum plane. In this embodiment, the installation angle θ is zero degrees for the initial value, but a calculation at a step S106 may be started from an arbitrary installation angle.

(Step S106): The deformation state calculation unit 54 deforms the cable model according to load conditions which have been input, to calculate the deformation state and an amount of the out-of-plane deformation of the cable 10 (corresponding to FIG. 6F; to FIG. 6G).

(Step S107): The deformation state calculation unit 54 judges whether the installation angle θ to designate the installation direction has reached the upper limit value θₘₐₓ (=360 degrees) or not. When the installation angle θ has not reached the upper limit value θₘₐₓ yet (in the case of No at step S107), the processing proceeds to step S108. On the other hand, when the installation angle θ has reached the upper limit value θₘₐₓ (in the case of Yes at step S107), the processing proceeds to step S109. Note that, in this example, the upper limit value θₘₐₓ is set to be 360 degrees, but it is not limited to that, and may be a predetermined appropriate value as far as the out-of-plane deformation can be properly evaluated.

(Step S108): The deformation state calculation unit 54 increases the installation angle θ by the predetermined angle increment Δθ to update the installation angle, and the processing returns to step S105.

(Step S109): The output operation unit 55 performs arithmetic operations of the deformation state and the range of dispersion of an amount of the out-of-plane deformation according to a load path to be assumed, and outputs those to the output device 42 (corresponding to FIG. 6G), and then those are showed by the output device 42.

Note that, the differences between the finite element analysis model to be made at step S102 and the finite element analysis model shown by FIG. 6A at step S103 will be explained. The length of the cable 10 and the loading conditions only differ from each other. The finite element analysis model to be made at step S102 does not require the modeling of the winding curl shown in FIG. 6B. As to the loading conditions, for example, in the case of three points bending test, time histories of displacement and load, and so on may be given. Therefore, a length of the cable of the finite element analysis model of FIG. 6A is properly changed, and the finite element analysis model to be made at step S102 can utilize the changed length.

### Confirmation of Operation and Effect of Embodiment

In order to confirm the effect of this embodiment, the inventors have manufactured the power cable 20 described in the following, and measured the amount of out-of-plane deformation of the cable to confirm an accuracy of the estimation.

### (Method of Manufacturing Power Cable)

Firstly, the cable 10 shown in FIG. 3 has been manufactured. A PE layer having a thickness of 0.5 mm is formed around the central conductor 12 having a diameter of 3.4 mm and 29 element wires 11 as the insulation layer 13, the reinforcing braided layer 14 is formed, and an EPDM layer having a thickness of 0.8 mm is formed as the resin sheath 15 of the outermost layer, sequentially, so that the cable 10 having an outer diameter of 8.0 mm is manufactured.

Next, the cable 10 is cut out from a bobbin with a length of 160 mm between connecting terminals 21 to manufacture the power cable 20. The cut-out cable 10 just after the cutting has a winding curl having a radius of curvature of approximate 100 mm because the cable has been wound around the bobbin to be kept.

Lastly, both ends of the cut-out cable 10 are processed with an end treatment and are attached with the connecting terminals 21 to manufacture the power cable 20.

### (Method of Measuring Out-Of-Plane Deformation)

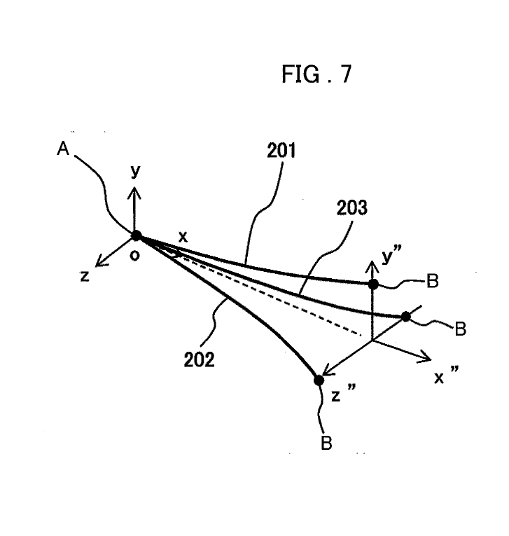

FIG. 7 is an explanation view showing an installation direction of a cable against the winding curl of the cable. And FIG. 7 is also an schematic view to understand the relation between a direction of the winding curl of the cable 10 and the plane (x-y plane) on which an L-form bending is applied to the cable 10. A method of measuring the out-of-plane deformation of the power cable 20 will be described with reference to FIG. 7.

An end (cable end A) of the power cable 20 is fixed to the coordinate origin O, and the other end (cable end B) of the power cable 20 is free, that is, for example, the cable end B is not held with a chuck or the like. In this state, FIG. 7 shows forms of the power cable 20, which forms designate the winding curl of the cable 10 when the winding curl of the cable 10 is supposed to clearly appear. Specifically, forms of power cables 201, 202, and 203 are shown.

In a more specific explanation, the direction of the winding curl of the cable 10 of the power cable 201 exists in the x-y plane, and the free cable end B is in the positive domain of the y-axis (y″-axis). Hereinafter, this state of being in the positive domain of the y-axis (y″-axis) is defined as zero degrees of the installation direction. The direction of the winding curl of the cable 10 of the power cable 202 exists in the x-z plane, and the free cable end B is in the positive domain of the z-axis (z″-axis). Hereinafter, this state of being in the positive domain of the z-axis (z″-axis) is defined as 90 degrees of the installation direction. The direction of the winding curl of the cable 10 of the power cable 203 exists in the x-z plane, and the free cable end B is in the negative domain of the z-axis (z″-axis). Hereinafter, this state of being in the negative domain of the z-axis (z″-axis) is defined as 270 degrees of the installation direction.

In measuring the out-of-plane deformation, after the cable end B is held with a chuck and is moved onto the x-axis (x″-axis), the cable end B is moved in the x-y plane so that the L-form bending is applied to the power cable 201, 202, 203. At this time, the maximum amount of out-of-plane deformation of the cable 10 in the direction Z for each power cable 201, 202, 203 is measured.

Note that, FIG. 7 is drawn on an assumption of the cable 10 having a predetermined length measured from the origin O which corresponds to, for example, the connecting terminal 21 in FIG. 1. In fact, the power cable 20 (or the cable 10) is bended to be an S form as shown in FIG. 1, but, the L-form bending of more basic deformation mode is a subject of this embodiment. An effect like that of this embodiment can be obtained also on the S-form bending because the S-form bending is a combination of L-form bendings.

The following table is a table indicating the effect of the embodiment. Specifically, an experimental result and an estimation result with regard to an amount of out-of-plane deformation are indicated for each case in which the (power) cable is bent to be like L form for the corresponding one of installation directions of zero degrees, 90 degrees, and 270 degrees. That is, the table indicates comparison results between measured values and estimated values according to the present invention with regard to an amount of out-of-plane deformation.

| | TABLE | | |
|---|---|---|---|
| | Installation direction (Unit: Degree) | | |
| | 0 | 90 | 270 |
| Measured Value | 0.68 mm | −1.28 mm | 1.41 mm |
| Estimated Value | 0.88 mm | −1.50 mm | 1.52 mm |

The apparatus 100 for estimation of out-of-plane deformation of a cable of this embodiment, the cable 10 having a winding curl which forces the cable to be an arc form under a stress-free-load state and including a conductor and a resin sheath 15 covering the conductor, includes: an input device 41 to input parameters needed for the estimation of the out-of-plane deformation of the cable 10 with reference to a datum plane, the out-of-plane deformation being caused when the cable is set in a horizontal state, a vertical plane including an axis of the cable in the horizontal state is set to be the datum plane, and the cable is bent in a vertical direction; an equivalent material property derivation unit 52 to derive a value of an equivalent material property of the whole of the cable 10 based on a stress-strain curve obtained by measurement; an analysis model making unit 53 to make a finite element analysis model of the cable 10 with use of the derived value of the equivalent material property of the cable 10, which model reproduces a form having a radius of curvature of the winding curl input by the input device 41 (for example, step S103, FIGS. 6A to 6C), to deform the cable model having the radius of curvature of the winding curl to be in a straight state and calculate a stress distribution in the straight cable model (step S104, FIG. 6D), and to set a rotational angle around an axis of the straight cable model for determining an installation direction of the winding curl (step S105, FIG. 6E); a deformation state calculation unit 54 to set the calculated stress distribution and the set rotational angle to be initial states, to deform the straight cable model according to a load condition input by the input device 41, and to calculate a deformation state and an amount of the out-of-plane deformation of the deformed cable model (step S106, FIG. 6F); and an output operation unit 55 to output calculation results (step S109, FIG. 6G) of the deformation state and the amount of the out-of-plane deformation of the deformed cable model to an output device 42.

The apparatus 100 executes the method for estimation of out-of-plane deformation of a cable and the dispersion of the deformation.

As described in the foregoing, the apparatus for estimation according to the present invention can estimate, with high accuracy, an amount of out-of-plane deformation of a cable and an amount of dispersion of the deformation which have been difficult to be estimated up to now when the cable is bent. As a result, a value of a clearance needed for being pulled around of the cable can be known beforehand. Then unexpected contact of the cable can be suppressed to the minimum.

Note that, the embodiments described in the foregoing are embodiments to promote a realization of the present invention. So the present invention is not limited to the embodiments including all constitutions described in the foregoing. For example, a part of constitutions of an embodiment can be replaced with a constitution of another embodiment. Furthermore, a constitution of another embodiment can be also added to constitutions of an embodiment. And furthermore, a part of constitutions of an embodiment can be deleted or replaced with another constitution, and another constitution can be added to constitutions of an embodiment. And an application range of the present invention is not limited to a cable for an in-wheel type motor, but the present invention can be applied to all types of cable to be bent like a cable for an industrial robot or other cables for a vehicle to be bent.

### DESCRIPTION OF REFERENCE SYMBOLS

10 Cable
11 Element Wire
12 Central Conductor (Conductor)
13 Insulation Layer
14 Reinforcing Braided Layer
15 Resin Sheath
20, 20a, 20b, 20c, 201, 201, 203 Power Cable
21 Connecting Terminal
30 In-wheel Type Motor
31 Suspension Arm
32 Suspension
33 Terminal Base
35 Wheel
41 Input Device
42 Output Device
43 Memory Unit
44 Cable Rigidity Measurement Unit
50 Data Processing Device
51 Control Unit
52 Equivalent Material Property Calculation Unit
53 Analysis Model Making Unit
54 Deformation State Calculation Unit
55 Output Operation Unit
100 Apparatus for Estimation

What is claimed is:

1. A method for estimation of out-of-plane deformation of a cable to be executed by an apparatus for estimation of out-of-plane deformation of the cable with reference to a datum plane, the cable having a winding curl which forces the cable to be an arc form under a stress-free-load state and including a conductor and a resin sheath covering the conductor, the out-of-plane deformation being caused when the cable is set in a horizontal state, a vertical plane including an axis of the cable in the horizontal state is set to be the datum plane, and the cable is bent in a vertical direction, the method comprising:
an input step of inputting parameters needed for the estimation of the out-of-plane deformation of the cable;
an equivalent material property derivation step of deriving a value of an equivalent material property of the whole of the cable based on a stress-strain curve obtained by measurement;
a winding curl form making step of making a finite element analysis model of the cable with use of the derived value of the equivalent material property of the cable, which model reproduces a form having a radius of curvature of the winding curl input at the input step;
a residual stress distribution calculation step of deforming the cable model having the radius of curvature of the winding curl to be in a straight state and calculating a stress distribution in the straight cable model;
a rotational angle setting step of setting a rotational angle around an axis of the straight cable model for determining an installation direction of the winding curl;
a cable deformation state calculation step of setting the calculated stress distribution and the set rotational angle to be initial states, deforming the straight cable model according to a load condition input at the input step, and calculating a deformation state and an amount of the out-of-plane deformation of the deformed cable model; and
a calculation result output step of outputting calculation results of the deformation state and the amount of the out-of-plane deformation of the deformed cable model to an output device.

2. The method for estimation of out-of-plane deformation of a cable according to claim 1, wherein the apparatus for estimation executes the residual stress distribution calculation step after deleting stress information after making the finite element analysis model.

3. An apparatus for estimation of out-of-plane deformation of a cable having a winding curl which forces the cable to be an arc form under a stress-free-load state and including a conductor and a resin sheath covering the conductor, comprising:
an input device to input parameters needed for the estimation of the out-of-plane deformation of the cable with reference to a datum plane, the out-of-plane deformation being caused when the cable is set in a horizontal state, a vertical plane including an axis of the cable in the horizontal state is set to be the datum plane, and the cable is bent in a vertical direction;
an equivalent material property derivation unit to derive a value of an equivalent material property of the whole of the cable based on a stress-strain curve obtained by measurement;
an analysis model making unit to make a finite element analysis model of the cable with use of the derived value of the equivalent material property of the cable, which model reproduces a form having a radius of curvature of the winding curl input by the input device, to deform the cable model having the radius of curvature of the winding curl to be in a straight state and calculate a stress distribution in the straight cable model, and to set a rotational angle around an axis of the straight cable model for determining an installation direction of the winding curl;
a deformation state calculation unit to set the calculated stress distribution and the set rotational angle to be initial states, to deform the straight cable model according to a load condition input by the input device, and to calculate a deformation state and an amount of the out-of-plane deformation of the deformed cable model; and
an output operation unit to output calculation results of the deformation state and the amount of the out-of-plane deformation of the deformed cable model to an output device.

4. The apparatus for estimation of out-of-plane deformation of a cable according to claim 3, wherein the analysis model making unit deletes stress information after making the finite element analysis model and before deforming the cable model having the radius of curvature of the winding curl to be in the straight state.
